(19) United States
(12) Patent Application Publication
(10) Pub. No.: US 2001/0004747 A1
(43) Pub. Date: Jun. 21, 2001

(54) Method and system for operating a computer system

(75) Inventors: Thomas Koehler, Holgerlingen (DE); Bernd Nerz, Boeblingen (DE); Thomas Streicher, Bietigheim-Bissingen (DE); Charles F. Webb, Poughkeepsie, NY (US)

Correspondence Address: Floyd A. Gonzalez, IBM Corporation, 2455 South Road, P386, Poughkeepsie, NY, 12601, US

(73) Assignee: International Business Machines Corporation, Armonk, NY (US)

(21) Appl. No.: 09/735,971

(22) Filed: Dec. 13, 2000

(30) Foreign Application Priority Data
Dec. 16, 1999 (EP) 99125154.7

(51) Int. Cl. G06F 3/00

(52) U.S. Cl. 710/48; 712/34; 710/52; 710/60

(57) ABSTRACT

A method of operating a computer system is described. The computer system comprises a processor and a co-processor wherein the co-processor is coupled to an output buffer for loading a number of output data units into the output buffer and wherein the processor is coupled to the output buffer for fetching the loaded output data units. The co-processor generates a trigger condition such that the last output data unit is being fetched by the processor from the output buffer as shortly as possible after it has been loaded to the output buffer by the co-processor.

### FIELD OF THE INVENTION

The invention relates to a method of operating a computer system comprising a processor and a co-processor wherein the co-processor is coupled to an output buffer for loading a number of output data units into the output buffer and wherein the processor is coupled to the output buffer for fetching the loaded output data units. The invention also relates to a corresponding computer system.

### BACKGROUND OF THE INVENTION

Such method and such computer system are generally known. For example, in an IBM S/390 computer system, a main processor has a co-processor for hardware data compression. This co-processor is also used for character translate instructions.

In this instruction, character data is converted by the co-processor from one notation into another notation. The converted character data is loaded into the output buffer by the co-processor. When the processor is going to fetch the character data from the output buffer, it has to check first that the character data have already been loaded into the output buffer by the co-processor. For that purpose, the co-processor signals to the processor the availability of a certain amount of character data in the output buffer. This leads to an inherent delay between character data having been loaded into the output buffer by the co-processor and the processor recognizing the availability of the character data in the output buffer. The speed at which the processor is able to fetch the character data from the output buffer is decreased by the overhead required for testing for the availability of character data in the output buffer.

This speed even more decreases if the co-processor is not able to generate and load the character data fast enough to the output buffer so that the processor has to test for the availability of character data several times.

### SUMMARY OF THE INVENTION

It is an object of the invention to increase the speed of the processor and to decrease the delay between co-processor and the processor.

This object is solved by a method of operating a computer system comprising a processor and a co-processor wherein the co-processor is coupled to an output buffer for loading a number of output data units into the output buffer, wherein the processor is coupled to the output buffer for fetching the loaded output data units, and wherein the co-processor generates a trigger condition such that the last output data unit is being fetched by the processor from the output buffer as shortly as possible after it has been loaded to the output buffer by the co-processor. Furthermore, the object is solved by a corresponding computer system.

The invention reduces the overhead for testing by the processor. The trigger condition is generated by the co-processor and has therefore no impact on the speed of the processor. This represents an increase of the speed of the processor. As well, the trigger condition is generated such that the last output data unit is fetched by the processor as shortly as possible after this output data unit has been loaded to the output buffer by the co-processor. Thereby, a delay between the co-processor and the processor is minimized.

In an advantageous embodiment of the invention, the co-processor generates the trigger condition such that the fetching of the output data units from the output buffer by the processor never bypasses the loading of the output data units into the output buffer by the co-processor. This ensures that the processor never has to test several times for the availability of character data. The speed of the processor is thereby increased.

It is advantageous that the co-processor considers the minimum amount of time required by the processor based on the assumption that every output data unit is available in the output buffer when being fetched by the processor and based on the assumption that no other tasks or waiting conditions become active. It is also advantageous that the co-processor considers the maximum amount of time required by the co-processor based on the assumption that all possible waiting conditions in the co-processor are counted with their maximum value and based on the processing speed of the co-processor and the number of remaining output data units to be generated by the co-processor and loaded to the output buffer.

In a further embodiment, the co-processor generates a trigger condition based on the minimum amount of time and the maximum amount of time. Then, the co-processor generates a trigger condition signal based on the trigger condition and sends the trigger condition signal to the processor.

In a further embodiment, the co-processor generates the trigger condition under consideration of a delay between the sending of the trigger condition signal by the co-processor and the recognition of the trigger condition signal by the processor. This leads to the result that the inherent delay between the co-processor and the processor is minimized. As a consequence, the co-processor generates the trigger condition such that the last output data unit is being fetched by the processor from the output buffer directly after it has been loaded to the output buffer by the co-processor.

According to the invention, the co-processor comprises a prediction circuitry for generating the trigger condition and for sending a trigger condition signal to the processor. This represents a further increase of the entire processing speed without having any impact on the speed of the processor.

Further advantages and embodiments of the invention will now be described in detail in connection with the accompanying drawing.

### BRIEF DESCRIPTION OF THE DRAWINGS

FIG. 1 is a schematic representation of a computer system according to the invention.

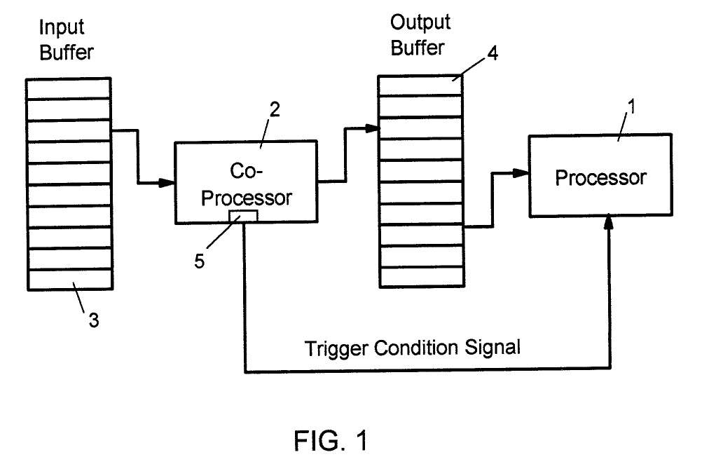

### DESCRIPTION OF THE PREFERRED EMBODIMENT

In the drawing, a computer systems comprises a processor 1 and a co-processor 2. The co-processor 2 is coupled to an input buffer 3 for receiving input data units. The co-processor 2 is also coupled to an output buffer 4 for loading output data units to the output buffer 4. The processor 1 is coupled to the output buffer 4 for fetching the output data units stored there. The output buffer 4 is a so-called FIFO, i.e. a first-in-first-out buffer.

It is assumed that an instruction is executed by the processor 1 together with the co-processor 2. Such instruction is associated with a certain amount of input data units and output data units. Both, the input buffer 3 and the output buffer 4 are assumed to be large enough to hold all input data units and all output data units.

Given that the processor 1 and the co-processor 2 are in the state of executing an instruction and all input data units have already been sent to the input buffer 3 and some of the output data units may have already been loaded by the co-processor 2 to the output buffer 4, but none of the output data units have been fetched by the processor 1 from the output buffer 4 yet, this will be referred to as state A. If the processor 1 and the co-processor 2 are executing an instruction and the output data units are going to be fetched or have already been fetched by the processor 1 from the output buffer 4, then this will be referred to as state B.

The processor 1 and the co-processor 2 are assumed to be in state A.

It is not possible to exactly determine the amount of time required by the processor 1 to fetch all output data units from the output buffer 4 because the processor 1 may be absorbed by other tasks or there could be some waiting conditions to be resolved.

But it is possible to determine the minimum amount of time required by the processor 1 based on the assumption that every output data unit is available in the output buffer 4 when being fetched by the processor 1 and based on the assumption that no other tasks or waiting conditions become active. This minimum amount of time required by the processor 1 depends on the total amount of data units associated with the instruction and the maximum speed of the processor 1 when fetching the output data units from the output buffer 4. This minimum amount of time required by the processor 1 is referred to as TPROCMIN.

It is also not possible to determine the exact amount of time required by the co-processor 2 for generating all remaining output data units and for loading them to the output buffer 4.

But it is possible to determine the maximum amount of time required by the co-processor 2 based on the assumption that all possible waiting conditions in the co-processor 2 are counted with their maximum value and based on the processing speed of the co-processor 2 and the number of remaining output data units to be generated and loaded to the output buffer 4. It is also possible to wait until all waiting conditions have been resolved and then to determine the amount of time required which in this case depends only on the number of remaining output data units and on the processing speed of the co-processor 2. This maximum amount of time required by the co-processor 2 is referred to as TCOPROCMAX.

When the processor 1 and the co-processor 2 are in state A. the co-processor 2 models TPROCMIN and TCOPROCMAX. However, the co-processor 2 does not predict the absolute values for TPROCMIN and TCOPROCMAX but only the condition

TCOPROCMAX<TPROCMIN.

This condition will be referred to as trigger condition.

When the processor 1 and the co-processor 2 are in state A, the trigger condition will become active at some point in time. Due to the trigger condition, it is impossible that output data units are going to be fetched from the output buffer 4 by the processor 1 before having been loaded to the output buffer 4 by the co-processor 2.

The trigger condition is generated by the co-processor 2 and sent as a trigger condition signal to the processor 1. When the processor 1 detects the trigger condition signal active, it performs the transition from state A to state B and fetches the total number of output data units associated with the instruction from the output buffer 4 at its maximum speed without further testing the availability of the output data units in the output buffer 4.

When generating the trigger condition, the co-processor 2 may additionally consider the delay between sending the trigger condition signal by the co-processor 2 and recognizing it in the processor 1. Such consideration results in sending the trigger condition signal earlier to compensate this delay.

Summarized, the trigger condition signal is timed such that, given the fetching of the output data units by the processor 1 happens at its maximum speed without additional delays, i) the last output data unit is being fetched by the processor 1 as shortly as possible after it has become available in the output buffer 4, and ii) the fetching of the output data units from the output buffer 4 by the processor 1 never bypasses the loading of the output data units into the output buffer 4 by the co-processor 2. By considering possible delays or the like as described above, it is possible that the last output data unit is being fetched by the processor 1 not only as shortly as possible, but even directly after it has become available in the output buffer 4. The generation of the trigger condition as well as the generation of the resulting trigger condition signal are performed by a prediction circuitry 5 implemented in the co-processor 2.

As an example, in an IBM S/390 computer system, the processor 1 has the co-processor 2 for hardware data compression. This co-processor 2 is also used for character translate instructions. The co-processor 2 comprises the prediction circuitry 5.

In such a character translate instruction, the co-processor 2 generates output data units and loads them to the output buffer 4 at a fix speed of one output data unit every four clock cycles. The code running on the processor 1 fetches output data units from the output buffer 4 at a maximum speed of one output data unit every two cycles. So the processor 1 fetches output data units from the output buffer 4 at two times the speed as the co-processor 2 loads them to the output buffer 4.

Therefore, the trigger condition will become active in state A as soon as the co-processor 2 has loaded more than half of the output data units to the output buffer 4.

The prediction circuitry 5 for generating the trigger condition consists of a counter which holds the number of output data units currently having been loaded to the output buffer 4 and a comparator which compares the value of this counter against the total amount of output data units associated with the instruction divided by two. When the counter value exceeds the compare value, then the trigger condition becomes active and the trigger condition signal is sent by the prediction circuitry 5 of the co-processor 2 to the processor 1.

While the preferred embodiment of the invention has been illustrated and described herein, it is to be understood that the invention is not limited to the precise construction herein disclosed, and the right is reserved to all changes and modifications coming within the scope of the invention as defined in the appended claims.

What is claimed is:

1. Method of operating a computer system having a processor and a co-processor, wherein the co-processor is coupled to an output buffer for loading a number of output data units into the output buffer, and wherein the processor is coupled to the output buffer for fetching the loaded output data units, said method comprising:
generating a trigger condition by the co-processor; and
fetching output data units by the processor from the output buffer responsive to said trigger condition such that the last output data unit fetched by the processor is as short as possible after it has been loaded to the output buffer by the co-processor.

2. Method of claim 1 wherein the co-processor generates the trigger condition such that the fetching of the output data units from the output buffer by the processor never bypasses the loading of the output data units into the output buffer by the co-processor.

3. Method of claim 1 wherein the co-processor calculates the minimum amount of time required by the processor based on the assumption that every output data unit is available in the output buffer when being fetched by the processor and based on the assumption that no other tasks or waiting conditions become active.

4. Method of claim 3 wherein the co-processor calculates the maximum amount of time required by the co-processor based on the assumption that all possible waiting conditions in the co-processor are counted with their maximum value and based on the processing speed of the co-processor and the number of remaining output data units to be generated by the co-processor and loaded to the output buffer.

5. Method of claim 4 wherein the co-processor generates a trigger condition based on said minimum amount of time and said maximum amount of time.

6. Method of claim 1 wherein the co-processor generates a trigger-condition signal based on said trigger condition and sends said trigger-condition signal to the processor.

7. Method of claim 6 wherein the co-processor generates said trigger condition including a delay between the sending of said trigger-condition signal by the co-processor and the recognition of said trigger-condition signal by the processor.

8. Computer system comprising:
a processor;
a co-processor;
an output buffer coupled to co-processor, said co-processor loading a number of output data units into the output buffer, said output buffer being further coupled to said processor for fetching the loaded output data units; and
a prediction circuit in said co-processor for generating a trigger condition such said processor fetches the last output data unit from the output buffer responsive to said trigger condition as shortly as possible after the last output data unit has been loaded to the output buffer by the co-processor.

9. Computer system of claim 8 wherein said prediction circuit generates the trigger condition such that the fetching of the output data units from the output buffer by the processor never bypasses the loading of the output data units into the output buffer by the co-processor.

10. Computer system of claim 8 wherein said prediction circuit calculates the minimum amount of time required by the processor based on the assumption that every output data unit is available in the output buffer when being fetched by the processor and based on the assumption that no other tasks or waiting conditions become active.

11. Computer system of claim 10 wherein said prediction circuit calculates the maximum amount of time required by the co-processor based on the assumption that all possible waiting conditions in the co-processor are counted with their maximum value and based on the processing speed of the co-processor and the number of remaining output data units to be generated by the co-processor and loaded to the output buffer.

12. Computer system of claim 11 wherein said prediction circuit generates a trigger condition based on said minimum amount of time and said maximum amount of time.

13. Computer system of claim 8 wherein said prediction circuit generates a trigger-condition signal based on the trigger condition and sends the trigger-condition signal to the processor.

14. Computer system of claim 13 wherein said prediction circuit generates said trigger condition including a delay between the sending of said trigger-condition signal by the co-processor and the recognition of said trigger-condition signal by the processor.
